(19) United States
(12) Patent Application Publication
(10) Pub. No.: US 2016/0173625 A1
(43) Pub. Date: Jun. 16, 2016

(54) SYSTEMS AND METHODS FOR SHARING MEDIA CONTENT WITH SOCIAL CONNECTIONS BASED ON LOCATION

(71) Applicant: Facebook, Inc., Menlo Park, CA (US)

(72) Inventors: William M. Ruben, San Francisco, CA (US); Ashwin Bharambe, Sunnyvale, CA (US); Laura Javier, Palo Alto, CA (US)

(21) Appl. No.: 14/972,010

(22) Filed: Dec. 16, 2015

Related U.S. Application Data
(63) Continuation of application No. 14/566,524, filed on Dec. 10, 2014.

(51) Int. Cl. H04L 29/08; H04L 29/06

(52) U.S. Cl. CPC H04L 67/18; H04L 67/306; H04L 65/403

(57) ABSTRACT

Systems, methods, and non-transitory computer-readable media can determine a current location of a first user. A set of users who are associated with the first user can be identified. In some instances, it can be determined that a second user out of the set of users is currently located within an allowable proximity from the current location of the first user. A first set of media content items produced by the first user can be shared with the second user.

### CROSS-REFERENCE TO RELATED APPLICATIONS

This application is a continuation of U.S. patent application Ser. No. 14/566,524, filed on Dec. 10, 2014 and entitled “SYSTEMS AND METHODS FOR SHARING MEDIA CONTENT WITH SOCIAL CONNECTIONS BASED ON LOCATION”, which is incorporated herein by reference.

### FIELD OF THE INVENTION

The present technology relates to the field of media content. More particularly, the present technology relates to techniques for sharing media content with social connections based on location.

### BACKGROUND

Today, people often utilize computing devices (or systems) for a wide variety of purposes. Users can use their computing devices to, for example, interact with one another, access content, share content, and create content. In some cases, a user can utilize his or her computing device to create media content items, such as images, videos, audio, and text. In some instances, it may also be desirable for the user to share at least some of the media content items with a social connection or friend within a social networking system (or service).

Under conventional approaches, media content associated with the user, such as images or videos created by the user, are generally shared in an inefficient or cumbersome manner. For example, conventional approaches generally require manual effort to select certain media content items to be shared. In another example, conventional approaches generally rely solely on manual effort to determine with whom the selected media content items are to be shared. Moreover, in a further example, conventional approaches generally require manual effort to initiate the sharing of the selected media content items. As such, conventional approaches can be inefficient and can create challenges for or reduce the overall user experience associated with sharing media content.

### SUMMARY

Various embodiments of the present disclosure can include systems, methods, and non-transitory computer readable media configured to determine a current location of a first user. A set of users who are associated with the first user can be identified. In some instances, it can be determined that a second user out of the set of users is currently located within an allowable proximity from the current location of the first user. A first set of media content items produced by the first user can be shared with the second user.

In an embodiment, a second set of media content items shared by the second user can be received by the first user.

In an embodiment, the first set of media content items and the second set of media content items can be included in a shared media content collection. In some cases, access to the shared media content collection can be provided to the first user and the second user.

In an embodiment, an interface for commenting with respect to the shared media content collection can be provided. In some instances, a textual remark can be received. The textual remark can be directed to a particular media content item within at least one of the first set or the second set. A comment can be presented via the interface. The comment can include the textual remark and a thumbnail preview of the particular media content item.

In an embodiment, metadata for the shared media content collection can be presented. The metadata can be based on at least one of the current location of the first user, the current location of the second user, an identifier for the first user, an identifier for the second user, or a time associated with the shared media content collection.

In an embodiment, it can be determined that a real-time media sharing option is enabled. At least a subset of the first set of media content items can be produced subsequent to the real-time media sharing option being enabled. In some cases, the at least the subset of the first set can be shared with the second user in real-time.

In an embodiment, the current location of the first user can be within a virtual boundary of a defined area.

In an embodiment, determining that the second user is within the allowable proximity can include determining that a current location of the second user is within the virtual boundary of the defined area.

In an embodiment, the sharing with the second user of the first set of media content items can cease when at least one of: 1) the current location of the first user becomes outside the virtual boundary of the defined area, 2) the current location of the first user becomes within a second defined area, 3) the current location of the second user becomes outside the virtual boundary of the defined area, or 4) an instruction to cease the sharing is received.

In an embodiment, at least one of a camera view or an image can be provided. A facial recognition process can be performed with respect to the at least one of the camera view or the image. A third user associated with the first user can be identified based on the facial recognition process. The first set of media content items produced by the first user can be shared with the third user.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example locational media content sharing module configured to facilitate sharing media content with social connections based on location, according to an embodiment of the present disclosure.

FIG. 2 illustrates an example location module configured to facilitate sharing media content with social connections based on location, according to an embodiment of the present disclosure.

FIG. 3 illustrates an example social connection module configured to facilitate sharing media content with social connections based on location, according to an embodiment of the present disclosure.

FIG. 4 illustrates an example media content module configured to facilitate sharing media content with social connections based on location, according to an embodiment of the present disclosure.

FIG. 5 illustrates an example scenario associated with sharing media content with social connections based on location, according to an embodiment of the present disclosure.

FIG. 6 illustrates an example scenario associated with sharing media content with social connections based on location, according to an embodiment of the present disclosure.

FIG. 7 illustrates an example scenario associated with sharing media content with social connections based on location, according to an embodiment of the present disclosure.

FIG. 8 illustrates an example method associated with sharing media content with social connections based on location, according to an embodiment of the present disclosure.

FIG. 9 illustrates a network diagram of an example system that can be utilized in various scenarios, according to an embodiment of the present disclosure.

FIG. 10 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

Sharing Media Content with Social Connections Based on Location

People use computing devices (or systems) for a wide variety of purposes. Computing devices can provide different kinds of functionality. Users can utilize their computing devices to produce information, access information, and share information. In some cases, users can use their computing devices to generate or produce media content items, such as by taking pictures, recording videos, etc. In some instances, users can decide to share at least some of these or other media content items with one or more of the users' social connections or friends within social networking systems (or services).

Conventional approaches to sharing media content generally require a significant amount of steps or actions to be taken in order for media content to be shared among users. Also, under conventional approaches to sharing media content, a significant amount of manual effort may be required to facilitate the sharing of media content. In some instances, conventional approaches may require a user to exert manual effort to select the media content to be shared. In some cases, the user has to exert effort in considering and deciding with which social connections the selected media content is to be shared, in accordance with conventional approaches. Furthermore, in some instances, conventional approaches may require the user to manually control the initiating (and/or ceasing) of the media content sharing. As such, these and other concerns associated with conventional approaches can cause media content sharing to be inefficient, inconvenient, and cumbersome.

Therefore, an improved approach to sharing media content can be beneficial for addressing or alleviating various concerns associated with conventional approaches. The disclosed technology enables the sharing of media content with social connections based on location. Various embodiments of the present disclosure can determine a current location of a first user. A set of users who are associated with the first user can be identified. In some instances, it can be determined that a second user out of the set of users is currently located within an allowable (or selected, predetermined, specified, etc.) proximity from the current location of the first user. A first set of media content items produced by the first user can be shared with the second user. It is contemplated that there can be many variations and/or other possibilities.

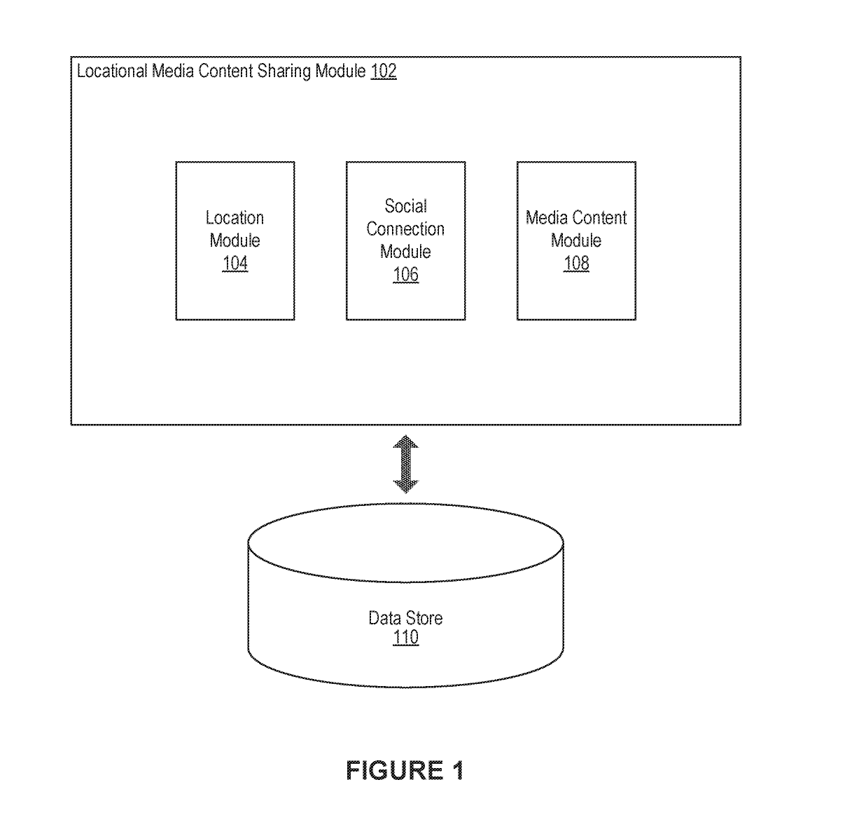

FIG. 1 illustrates an example system 100 including an example locational media content sharing module 102 configured to facilitate sharing media content with social connections based on location, according to an embodiment of the present disclosure. As shown in the example of FIG. 1, the locational media content sharing module 102 can include a location module 104, a social connection module 106, and a media content module 108. In some instances, the example system 100 can also include at least one data store 110. The components (e.g., modules, elements, etc.) shown in this figure and all figures herein are exemplary only, and other implementations may include additional, fewer, integrated, or different components. Some components may not be shown so as not to obscure relevant details.

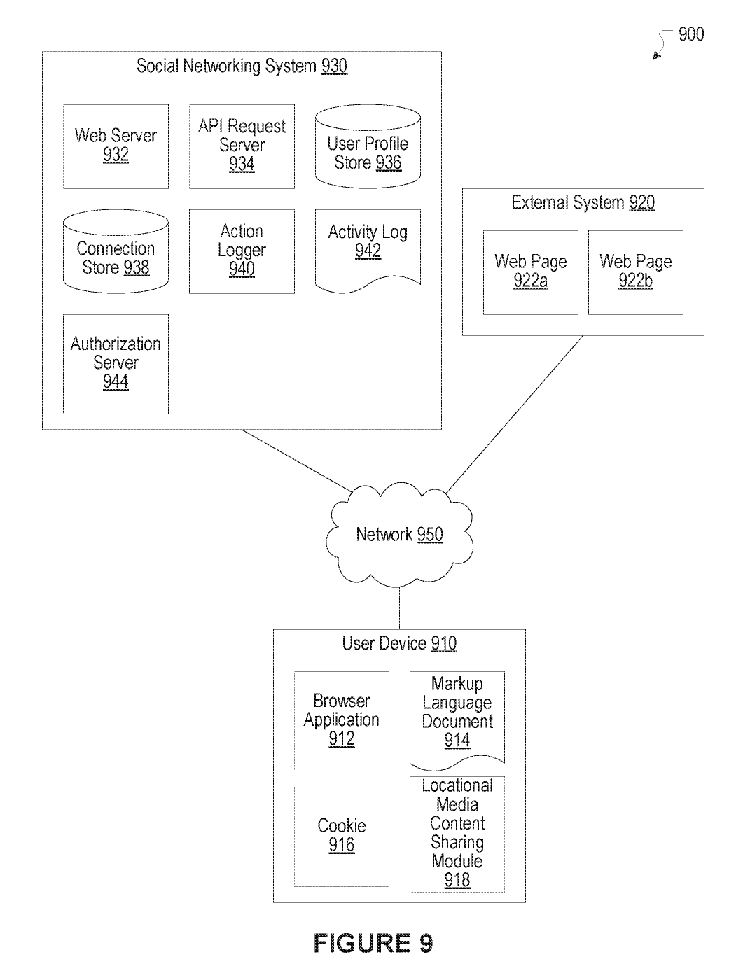

In some embodiments, the locational media content sharing module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the example locational media content sharing module 102 can be implemented, in part or in whole, as software running on one or more computing devices or systems, such as on a user or client computing device. For example, the locational media content sharing module 102 can be implemented as or within an application (e.g., app), a program, or an applet, etc., running on a user computing device or client computing system. In some instances, the locational media content sharing module 102 can, in part or in whole, be implemented within or configured to operate in conjunction with a social networking system (or service), such as the social networking system 930 of FIG. 9. It should be understood that many variations are possible.

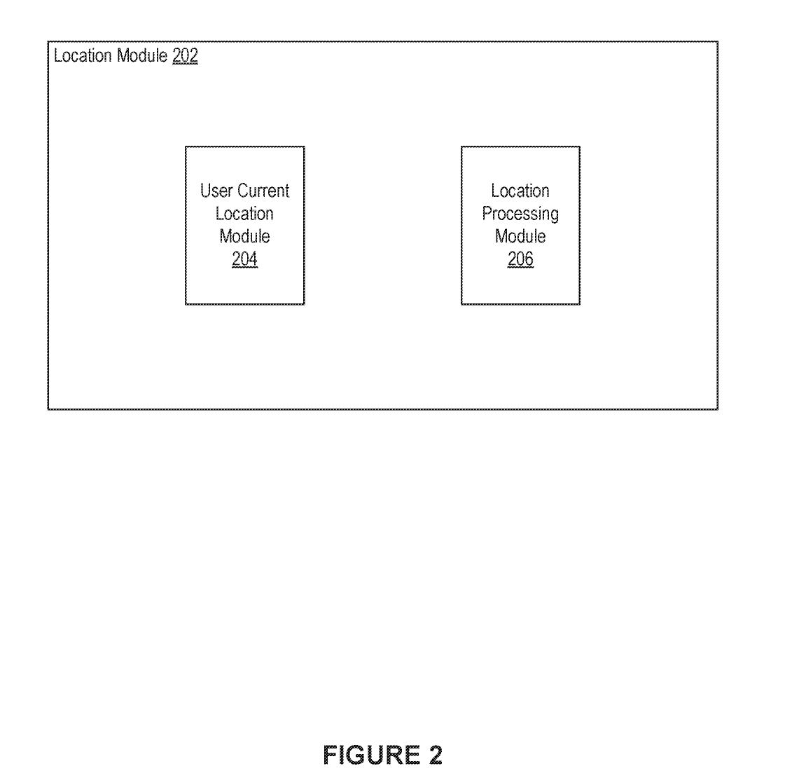

In some implementations, the location module 104 can be configured to facilitate determining a current location of a first user. For example, the location module 104 can incorporate or operate with one or more location sensors of a computing device (or system) of the first user. The current location of the first user can be determined by the location module 104 based on Global Positioning System (GPS) data, Wi-Fi data, Bluetooth signal data, cellular triangular data, and/or radio signal multilateration data, etc. More details regarding the location module 104 will be provided below with reference to FIG. 2.

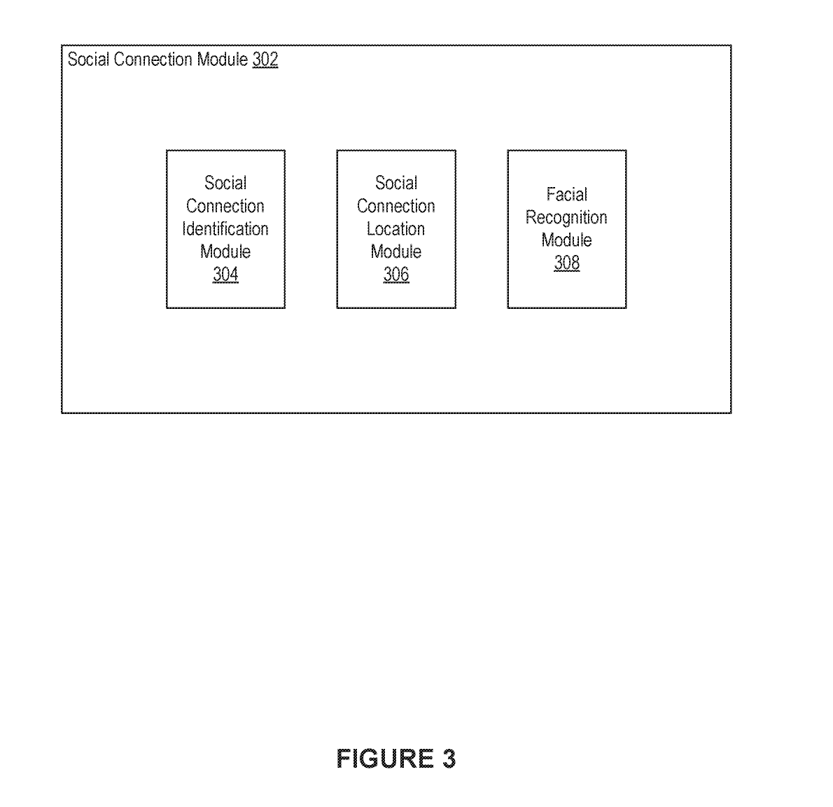

The social connection module 106 can be configured to facilitate identifying a set of users who are associated with the first user. In one example, the social connection module 106 can identify all of the first user's social connections or friends within the social networking system or service (e.g., the social networking system 930 of FIG. 9). In some implementations, the social connection module 106 can communicate or operate with the at least one data store 110 to identify the set of social connections or friends associated with the first user. Moreover, the social connection module 106 can be configured to facilitate determining that a second user out of the set of users is currently located within an allowable proximity from the current location of the first user. For example, the social connection module 106 can receive or acquire information indicating that the second user, who is a friend of the first user, is currently located within the allowable proximity from the current location of the first user. The social connection module 106 will be described in more detail below with reference to FIG. 3.

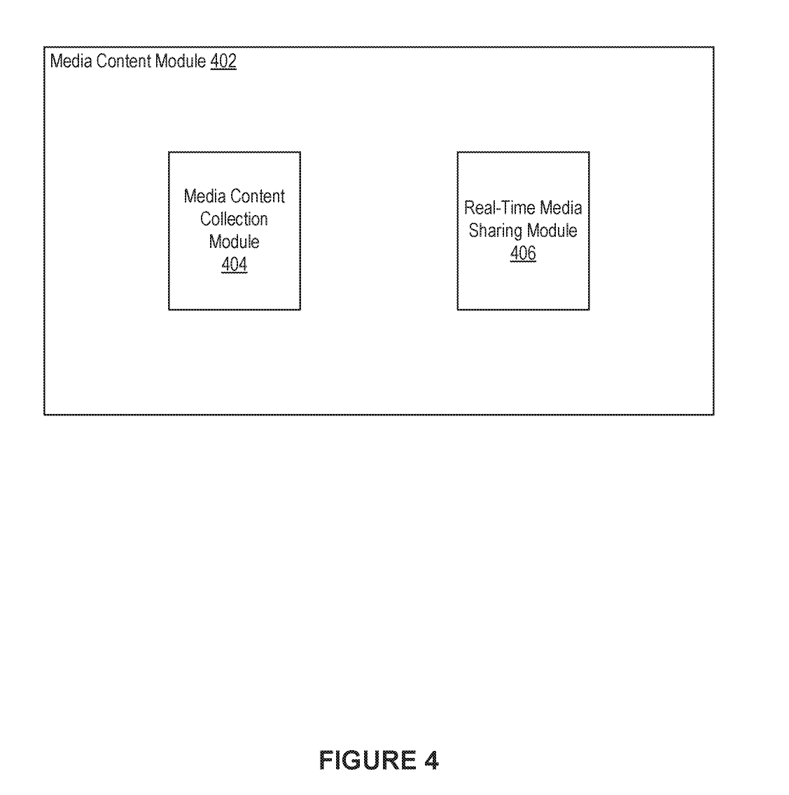

The media content module 108 can be configured to facilitate sharing with the second user a first set of media content items produced (or captured, controlled, uploaded, shared, etc.) by the first user. In some cases, the media content module 108 can also be configured to facilitate sharing with the first user a second set of media content items produced by the second user. More details regarding the media content module 108 will be provided below with reference to FIG. 4.

Furthermore, the at least one data store 110 can be configured to store and maintain various types of data. In some implementations, the at least one data store 110 can store information associated with the social networking system (e.g., the social networking system 930 of FIG. 9). The information associated with the social networking system can include data about users, social connections, social interactions, locations, geo-fenced areas, maps, places, events, groups, posts, communications, content, account settings, privacy settings, a social graph, and various other types of data. In some implementations, the at least one data store 110 can store information associated with users, such as user identifiers, user information, user specified settings, content produced by users, and various other types of user data. As shown in the example system 100, the locational media content sharing module 102 can be configured to communicate and/or operate with the at least one data store 110.

In one example, the first user is attending a picnic party with a group of people, which includes some friends of the first user. In this example, the locational media content sharing module 102 can determine the current location of the first user based on GPS signals of the first user's computing device. The first user's current location can be determined to be within a particular defined geographical area or place, such as Park ABC. Moreover, the locational media content sharing module 102 can identify a set of users who are socially connected to or friends with the first user through the social networking system. The set of users can include, for example, a second user, a third user, a fourth user, and many other social connections. In this example, the second and third users are also attending the picnic party at Park ABC, but the fourth user and the other social connections are not. Furthermore, the second user has enabled location services on the second user's computing device (or system), but the third user has not enabled location services for the third user's computing device.

Continuing with the example, the locational media content sharing module 102 can determine or acquire information indicating that the second user's current location is within the allowable proximity from the first user's current location (e.g., that the second user's current location is also within the particular defined geographical area or place). Further, while at the current location, the first user can generate or produce a first set of one or more media content items. The locational media content sharing module 102 can suggest or recommend including the first set of media content items in a media content collection to be shared with the second user. If the first user and the second user both agree, then the media content collection including the first set of media content items can be shared among the first user and the second user. Also, when the second user generates or produces a second set of one or more media content items at the current location, the second set can be included in the shared media content collection such that both the first and second users can access both the first and second sets of media content items. In some implementations, the media content collection can be shared in real-time as media content items are produced by the first user and/or the second user.

As discussed above, in this example, the third user has not enabled location services for the third user's computing device. Nonetheless, in some embodiments, if the first user uses his or her computing device to provide a real-time camera view or to capture an image, where the camera view or the image includes or shows the third user's face, then, subject to privacy settings, the locational media content module 102 can perform facial recognition on the camera view or the image to recognize the third user out of the set of social connections of the first user. The locational media content module 102 can then suggest or recommend that the media content collection be shared with the third user. In some instances, the sharing of media content can cease based on specified settings and/or instructions.

FIG. 2 illustrates an example location module 202 configured to facilitate sharing media content with social connections based on location, according to an embodiment of the present disclosure. In some embodiments, the location module 104 of FIG. 1 can be implemented as the example location module 202. As shown in the example of FIG. 2, the example location module 202 can include a user current location module 204 and a location processing module 206.

The user current location module 204 can be configured to facilitate determining a current location of a first user. In some implementations, the user current location module 204 can include or operate with one or more location sensors of a computing device (or system) of the first user. For example, the user current location module 204 can utilize one or more GPS chips, Wi-Fi transceivers, and/or cellular transceivers, etc., of the first user's computing device to facilitate determining the current location of the first user (i.e., the current location of the first user's computing device).

The location processing module 206 can be configured to process various types of locational information, such as data representing the current location of the first user. In some embodiments, the location processing module 206 can receive or otherwise acquire the current location of the first user from the user current location module 204. The location processing module 206 can determine whether or not the current location of the first user is within a virtual boundary of a defined area. For example, the location processing module 206 can communicate and/or operate with the data store 110 of FIG. 1 to determine whether the first user's current location is within the defined area. In some instances, the defined area can correspond to a particular geo-fenced area or place defined by a social networking system or service. In some cases, the defined area can be formed, created, and/or defined based on check-in information. Further, in some implementations, the location processing module 206 can request confirmation from the first user that the first user's current location has been determined correctly. Otherwise, the first user can input his or her current location. It should be appreciated that many variations are possible.

Moreover, in some embodiments, the location processing module 206 can recognize, label, tag, and/or categorize media content items produced by the first user (e.g., images captured by the first user's computing device, videos recorded by the first user's computing device, etc.) as being associated with the current location of the first user.

FIG. 3 illustrates an example social connection module 302 configured to facilitate sharing media content with social connections based on location, according to an embodiment of the present disclosure. In some embodiments, the social connection module 106 of FIG. 1 can be implemented as the example social connection module 302. As shown in the example of FIG. 3, the example social connection module 302 can include a social connection identification module 304 and a social connection location module 306. In some implementations, the example social connection module 302 can also include a facial recognition module 308.

The social connection identification module 304 can be configured to facilitate identifying a set of users who are associated with a first user. In some cases, the social connection identification module 304 can identify a set of all the social connections or friends of the first user within a social networking system or service. For example, the social connection identification module 304 can communicate or operate with the data store 110 of FIG. 1 to query, acquire, and/or receive identifying information about the first user's social connections or friends.

The social connection location module 306 can be configured to facilitate determining that a second user out of the set of users is currently located within an allowable proximity from the current location of the first user. In some implementations, the social connection location module 306 can check the identified set of users to determine whether or not any users in the set are currently located within the allowable proximity from the current location of the first user. As discussed above, in some cases, the current location of the first user can be within a virtual boundary of a defined area. Accordingly, in some embodiments, the social connection location module 306 can determine, receive, and/or acquire a current location of, at least, the second user. Moreover, the social connection location module 306 can determine or deem the second user as being within the allowable proximity when the current location of the second user is determined to be within the virtual boundary of the defined area. When the second user is determined to be within the allowable proximity from the current location of the first user, media content can be shared between the first user and the second user, in accordance with various embodiments of the present disclosure.

Furthermore, in some embodiments, the facial recognition module 308 can be configured to perform a facial recognition process in attempt to recognize or identify one or more social connections or friends of the first user. In one example, a camera view or an image can be provided. The camera view can correspond to a live camera view of a camera of the first user's computing device. The image can correspond to a photograph captured using the first user's computing device. The facial recognition module 306 can perform the facial recognition process with respect to the camera view or the image. The facial recognition module 306 can identify, based on the facial recognition process, a third user out of the set of users associated with the first user. In some cases, various embodiments can enable media content to be shared among the first user and the third user. In some instances, media content can be shared among the first, second, and third users. It should be understood that there can be many other variations.

FIG. 4 illustrates an example media content module 402 configured to facilitate sharing media content with social connections based on location, according to an embodiment of the present disclosure. In some embodiments, the media content module 108 of FIG. 1 can be implemented as the example media content module 402. As shown in the example of FIG. 4, the example media content module 402 can include a media content collection module 404 and a real-time media sharing module 406.

The media content module 402 can be configured to facilitate sharing media content. In some instances, the media content module 402 can share with a second user a first set of media content items produced by a first user, as discussed previously. In some cases, the media content module 402 can also be configured to receive a second set of media content items shared by the second user. The media content module 402 can share the received second set of media content item with the first user.

Moreover, in some embodiments, the media content collection module 404 can cause the first set of media content items and the second set of media content items to be included in a shared media content collection. The media content collection module 404 can provide the first user and the second user with access to the shared media content collection. It is contemplated that many variations are possible. For example, in some cases, the media content collection module 404 can create and share a new media content collection at substantially a new time and/or location when new media content items are produced from users at the new time and/or location. Accordingly, there can be multiple shared media content collections, including different media content, that are shared among multiple groups of users.

Furthermore, in some implementations, the media content collection module 404 can be configured to provide an interface for commenting with respect to a particular shared media content collection. In some cases, one of the users in the particular shared media content collection can provide a textual remark (e.g., words, emoticons, etc.) directed to the particular shared media content collection as a whole. The media content collection module 404 can present the textual remark as a comment via the interface. In some instances, the media content collection module 404 can receive a textual remark directed to a particular media content item within the particular shared media content collection (e.g., within the first set and/or the second set of media content items). The media content collection module 404 can present a comment via the interface. The comment can include the textual remark and a thumbnail preview of the particular media content item. In some embodiments, there can be an interface to provide information about social interactions or engagements (e.g., comments, likes, notifications of new media content, notifications of new members, etc.) related to the particular shared media content collection, similar to an activity feed.

In addition, the media content collection module 404 can be configured to present metadata for the shared media content collection. In some embodiments, the metadata can be based on at least one of the current location of the first user, the current location of the second user, an identifier for the first user, an identifier for the second user, or a time associated with the shared media content collection. In one example, the metadata can be presented as a title and/or description for the shared media content collection.

The real-time media sharing module 406 can be configured to determine that a real-time media sharing option has been enabled, such as by a command from the first user. In some cases, at least a subset of the first set of media content items can be produced subsequent to the real-time media sharing option being enabled. The real-time media sharing module 406 can share with the second user in real-time the at least the subset of the first set of media content items. For example, while the real-time media sharing option is enabled, each media content item produced by a user who has access to the shared media content collection (i.e., a member of the shared media content collection) can be immediately be initiated for transmission or sharing with the other member users.

In some embodiments, the media content module 402 can cease the sharing of the first set of media content items with the second user based on specified settings or instructions. For example, the media content module 402 can cease the sharing of the first set of media content items with the second user when the current location of the first user becomes outside a virtual boundary of the defined area, when the current location of the first user becomes within a second defined area, when the current location of the second user becomes outside the virtual boundary of the defined area, and/or when an instruction to cease the sharing is received. It should be appreciated that many variations are possible.

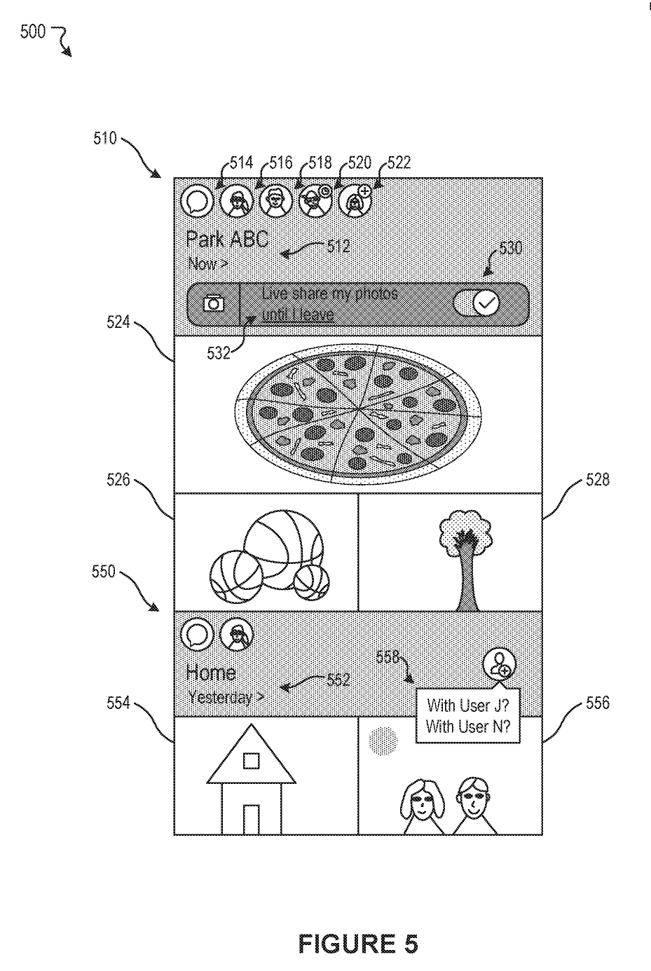

FIG. 5 illustrates an example scenario 500 associated with sharing media content with social connections based on location, according to an embodiment of the present disclosure. The example scenario 500 illustrates a first shared media content collection 510 and a second shared media content collection 550, which are provided on a computing system (or device) of a first user, e.g., User A 516.

In the example scenario 500, the first shared media content collection 510 can correspond to a first shared media album. The first shared media content collection 510 can relate to a first particular event or moment (e.g., particular location, time, and people). In this example, metadata 512 for the first shared media content collection 510, such as a title and/or a description, can be generated and presented. As discussed, in some cases, the metadata 512 can be based on the current location and/or time. In this example, the current location is determined to be at, within, or near “Park ABC”, and the time is presented as “Now’. There can also be an option 514 to provide comments or feedback for the first shared media content collection 510.

Continuing with the example scenario 500, User A 516 and User B 518 can both be currently located near, at, or within Park ABC. As such, the first shared media content collection 510 can be shared among User A 516 and User B 518. A request for User C 520 to join as a member of a group with rights to view the first shared media content collection 510 has also been transmitted to User C 520. Accordingly, there is a clock icon overlaying the user icon for User C 520. Furthermore, a request from User D 522 to join the group with rights to view the first shared media content collection 510 has also been received. As such, there is a plus sign icon overlaying the user icon for User D 522. Many variations are possible.

In this example, the media contents items (e.g., image 524, image 526, image 528, etc.) within the first shared media content collection 510 are only accessible by User A 516 and User B 518. Moreover, User A 516 and User B 518 can add media content items to the first shared media content collection 510. When User C 520 and User D 522 have successfully joined the group with rights to view the first shared media content collection 510, then they can have access to and can add media content to the first shared media content collection 510.

It is also important to note that various embodiments of the present disclosure can comply with one or more privacy settings, user preferences, etc. For example, if a user has set a media content item to be private, then even if the media content item is included in the shared media content collection, the media content item will nonetheless remain inaccessible to other users.

Continuing with the example of FIG. 5, a live mode or real-time media sharing option 530 can be enabled. Therefore, an automatic transmission or automatic sharing of media content produced by User A 516 can be initiated immediately or in (or near) real-time. As such, the time metadata is presented as “Now’. Furthermore, User A 516 can select an option 532 to indicate when the automatic sharing is to be ceased. In this example, the automatic sharing will cease or stop when User A 516 moves outside a virtual boundary of Park ABC. In some instances, there can be an icon, such as a blinking or pulsing icon, to indicate that the live-mode or real-time media sharing option is active.

Moreover, in the example scenario 500, the second shared media content collection 550 can correspond to a second shared media album. The second shared media content collection 550 can relate to a second particular event or moment. In some embodiments, metadata presented to a viewing user can be adjusted accordingly based on the unique disposition or perspective of the user. For example, if the second shared media content collection 550 is associated with User A's home, then the metadata 552 presented to User A 516 can state “Home”. However, if the metadata for the second shared media content collection 550 is presented to User B 518, then the metadata can state “User A's Home”. Moreover, as shown, the second shared media content collection 550 can include media content items, such as image 554 and image 556.

In some implementations, facial recognition can be applied to images (and/or camera views). In this example, facial recognition can be performed on image 556, and as a result, there can be a suggestion or recommendation 558 to add to the group with rights to view the second shared media content collection 550 User J and User N, who have been recommended as potential candidates with whom the second media content collection 550 can be shared.

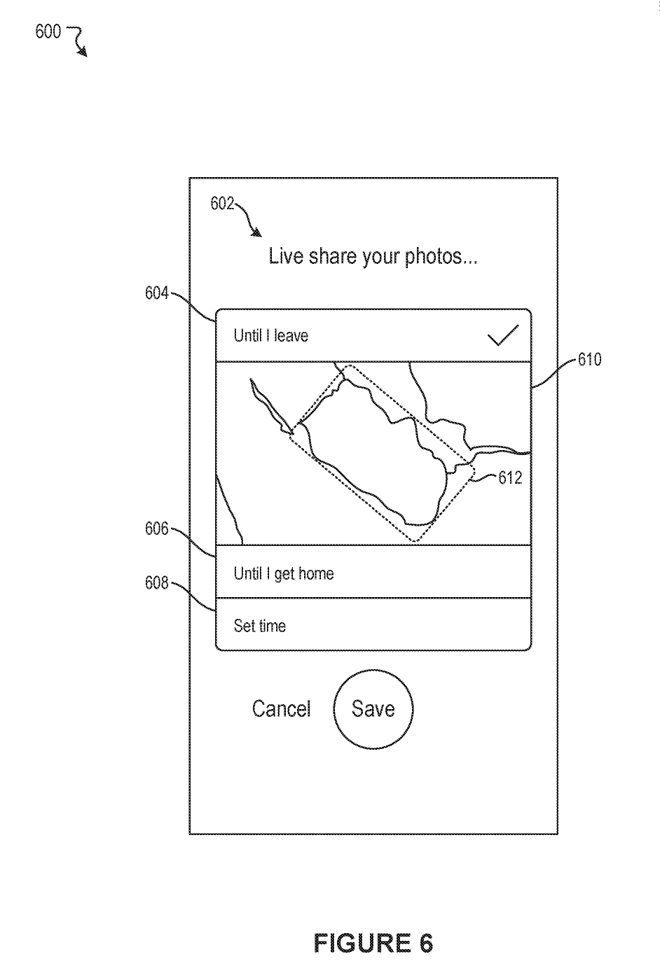

FIG. 6 illustrates an example scenario 600 associated with sharing media content with social connections based on location, according to an embodiment of the present disclosure. In the example scenario 600, a live mode or real-time automatic media sharing option 602 has been enabled. In some embodiments, there can be an option 604 to cease automatic real-time media sharing when a sharing user leaves a particular area. As shown in this example, there can also be an option 606 to cease automatic real-time media sharing when the current location of the first user becomes within a second defined area (e.g., when the first user gets home, when the first user gets to work, etc.). There can also be an option 608 to cease sharing when an instruction is received (e.g., an instruction to cease sharing after a set/specified amount of time, an instruction to cease sharing immediately, etc.).

In some implementations, the particular area (e.g., event location, premise, store, establishment, park, area, home, work location, etc.) can be shown via an interface 610. In the example scenario 600, the particular area can have a virtual boundary 612. In some instances, the interface 610 can be provided by the locational media content sharing module 102 of FIG. 1. It is understood that many variations are possible.

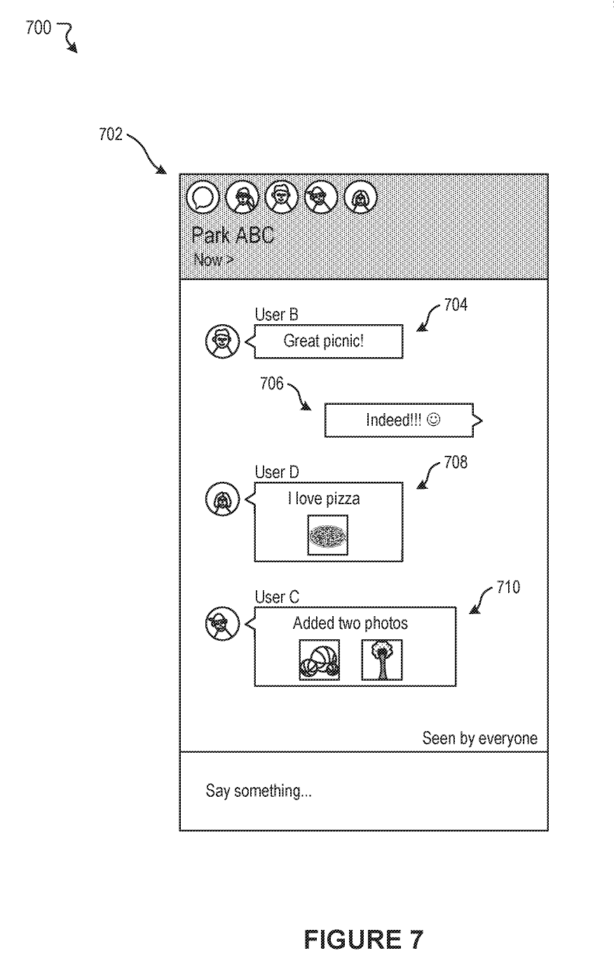

FIG. 7 illustrates an example scenario 700 associated with sharing media content with social connections based on location, according to an embodiment of the present disclosure. In the example scenario 700, an interface 702 for commenting with respect to a shared media content collection can be provided. The example scenario 700 shows a first comment 704 and a second comment 706, each of which is directed at or otherwise associated with the shared media content collection. The example scenario 700 also shows a third comment 708 that is directed at a particular media content item (e.g., image 524 in FIG. 5) within the shared media content collection. Moreover, in some cases, there can be a notification 710 associated with an activity, such the adding of media content items. Again, it should be appreciated that many variations are possible.

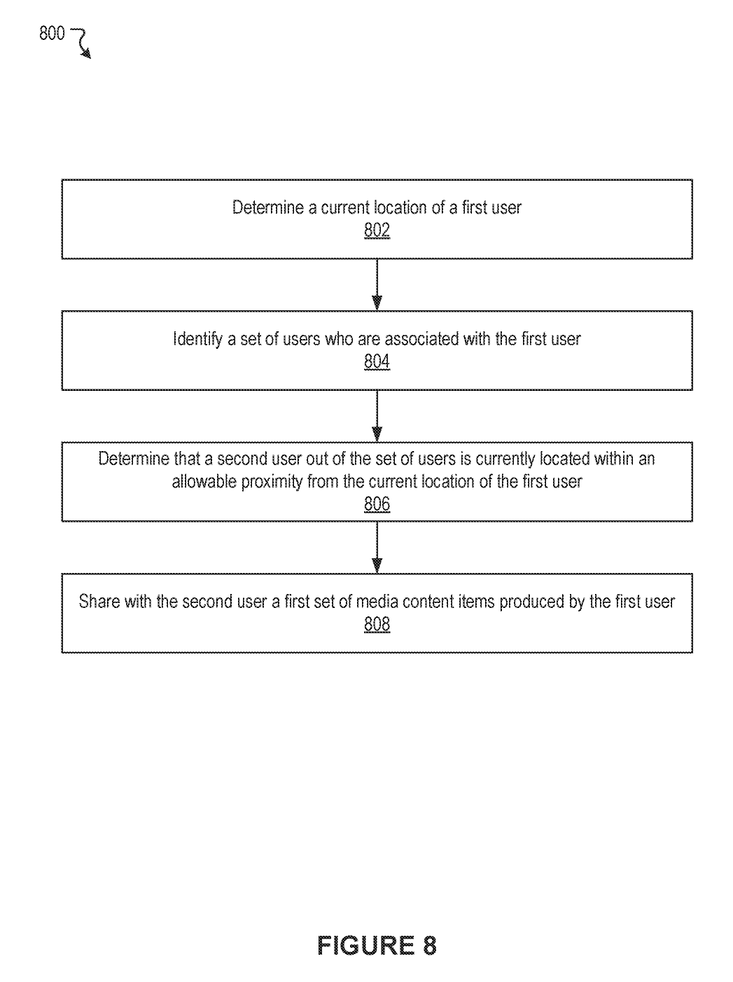

FIG. 8 illustrates an example method 800 associated with sharing media content with social connections based on location, according to an embodiment of the present disclosure. It should be appreciated that there can be additional, fewer, or alternative steps performed in similar or alternative orders, or in parallel, within the scope of the various embodiments unless otherwise stated.

At block 802, the example method 800 can determine a current location of a first user. At block 804, the example method 800 can identify a set of users who are associated with the first user. At block 804, the example method 800 can determine that a second user out of the set of users is currently located within an allowable proximity from the current location of the first user. At block 804, the example method 800 can share with the second user a first set of media content items produced by the first user.

In some embodiments, a title, description, and/or other properties for a shared media content collection can be manually provided.

In some embodiments, a user who produced and shared a media content item within a shared media content collection can remove the media content item from the shared media content collection. In some cases, a user who did not produce a shared media content item can hide from view, but cannot remove, the shared media content item.

In some embodiments, a user can be removed from a group with rights to view a shared media content collection. For examples, the user can remove himself or herself from the group with rights to view the shared media content collection and any media content shared by the user can also be removed from the shared media content collection. In another example, a first user can, in some cases, remove a second user from the group with rights to view the shared media content collection. In a further example, membership to join the group with rights to view the shared media content collection can be locked.

In some embodiments, media content items, such as images, that are determined to be the same or sufficiently similar can be consolidated or stacked for more convenient viewing. For example, in some cases, classification analysis can be performed on media content items to determine their potential relevance with a particular subject, topic, and/or theme. The classification analysis can be based on myriad techniques, for example. Content items constituting or including images or text can be analyzed and classified based on any suitable processing technique. For example, an image classification technique can gather contextual cues for a sample set of images and use the contextual cues to generate a training set of images. The training set of images can be used to train a classifier to generate visual pattern templates of an image class. The classifier can score an evaluation set of images based on correlation with the visual pattern templates. The highest scoring images of the evaluation set of images can be deemed to be mostly closely related to the image class. As another example, a hint detection technique can include natural language processing (NLP) to assist in identifying hints in comments associated with an image. The NLP-based hint detection technique can identify, based at least in part on natural language processing, one or more tokens in a comment that can assist in determining the subject matter of an image. Other suitable techniques are possible.

Again, it is contemplated that there can be many other uses, applications, and/or variations associated with the various embodiments of the present disclosure. For example, various embodiments of the present disclosure can learn, improve, and/or be refined over time.

### Social Networking System—Example Implementation

FIG. 9 illustrates a network diagram of an example system 900 that can be utilized in various scenarios, in accordance with an embodiment of the present disclosure. The system 900 includes one or more user devices 910, one or more external systems 920, a social networking system (or service) 930, and a network 950. In an embodiment, the social networking service, provider, and/or system discussed in connection with the embodiments described above may be implemented as the social networking system 930. For purposes of illustration, the embodiment of the system 900, shown by FIG. 9, includes a single external system 920 and a single user device 910. However, in other embodiments, the system 900 may include more user devices 910 and/or more external systems 920. In certain embodiments, the social networking system 930 is operated by a social network provider, whereas the external systems 920 are separate from the social networking system 930 in that they may be operated by different entities. In various embodiments, however, the social networking system 930 and the external systems 920 operate in conjunction to provide social networking services to users (or members) of the social networking system 930. In this sense, the social networking system 930 provides a platform or backbone, which other systems, such as external systems 920, may use to provide social networking services and functionalities to users across the Internet.

The user device 910 comprises one or more computing devices that can receive input from a user and transmit and receive data via the network 950. In one embodiment, the user device 910 is a conventional computer system executing, for example, a Microsoft Windows compatible operating system (OS), Apple OS X, and/or a Linux distribution. In another embodiment, the user device 910 can be a device having computer functionality, such as a smart-phone, a tablet, a personal digital assistant (PDA), a mobile telephone, etc. The user device 910 is configured to communicate via the network 950. The user device 910 can execute an application, for example, a browser application that allows a user of the user device 910 to interact with the social networking system 930. In another embodiment, the user device 910 interacts with the social networking system 930 through an application programming interface (API) provided by the native operating system of the user device 910, such as iOS and ANDROID. The user device 910 is configured to communicate with the external system 920 and the social networking system 930 via the network 950, which may comprise any combination of local area and/or wide area networks, using wired and/or wireless communication systems.

In one embodiment, the network 950 uses standard communications technologies and protocols. Thus, the network 950 can include links using technologies such as Ethernet, 702.11, worldwide interoperability for microwave access (WiMAX), 3G, 4G, CDMA, GSM, LTE, digital subscriber line (DSL), etc. Similarly, the networking protocols used on the network 950 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 950 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 910 may display content from the external system 920 and/or from the social networking system 930 by processing a markup language document 914 received from the external system 920 and from the social networking system 930 using a browser application 912. The markup language document 914 identifies content and one or more instructions describing formatting or presentation of the content. By executing the instructions included in the markup language document 914, the browser application 912 displays the identified content using the format or presentation described by the markup language document 914. For example, the markup language document 914 includes instructions for generating and displaying a web page having multiple frames that include text and/or image data retrieved from the external system 920 and the social networking system 930. In various embodiments, the markup language document 914 comprises a data file including extensible markup language (XML) data, extensible hypertext markup language (XHTML) data, or other markup language data. Additionally, the markup language document 914 may include JavaScript Object Notation (JSON) data, JSON with padding (JSONP), and JavaScript data to facilitate data-interchange between the external system 920 and the user device 910. The browser application 912 on the user device 910 may use a JavaScript compiler to decode the markup language document 914.

The markup language document 914 may also include, or link to, applications or application frameworks such as FLASH™ or Unity™ applications, the SilverLight™ application framework, etc.

In one embodiment, the user device 910 also includes one or more cookies 916 including data indicating whether a user of the user device 910 is logged into the social networking system 930, which may enable modification of the data communicated from the social networking system 930 to the user device 910.

The external system 920 includes one or more web servers that include one or more web pages 922a, 922b, which are communicated to the user device 910 using the network 950. The external system 920 is separate from the social networking system 930. For example, the external system 920 is associated with a first domain, while the social networking system 930 is associated with a separate social networking domain. Web pages 922a, 922b, included in the external system 920, comprise markup language documents 914 identifying content and including instructions specifying formatting or presentation of the identified content.

The social networking system 930 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 930 may be administered, managed, or controlled by an operator. The operator of the social networking system 930 may be a human being, an automated application, or a series of applications for managing content, regulating policies, and collecting usage metrics within the social networking system 930. Any type of operator may be used.

Users may join the social networking system 930 and then add connections to any number of other users of the social networking system 930 to whom they desire to be connected. As used herein, the term “friend” refers to any other user of the social networking system 930 to whom a user has formed a connection, association, or relationship via the social networking system 930. For example, in an embodiment, if users in the social networking system 930 are represented as nodes in the social graph, the term “friend” can refer to an edge formed between and directly connecting two user nodes.

Connections may be added explicitly by a user or may be automatically created by the social networking system 930 based on common characteristics of the users (e.g., users who are alumni of the same educational institution). For example, a first user specifically selects a particular other user to be a friend. Connections in the social networking system 930 are usually in both directions, but need not be, so the terms “user” and “friend” depend on the frame of reference. Connections between users of the social networking system 930 are usually bilateral (“two-way”), or “mutual,” but connections may also be unilateral, or “one-way.” For example, if Bob and Joe are both users of the social networking system 930 and connected to each other, Bob and Joe are each other's connections. If, on the other hand, Bob wishes to connect to Joe to view data communicated to the social networking system 930 by Joe, but Joe does not wish to form a mutual connection, a unilateral connection may be established. The connection between users may be a direct connection; however, some embodiments of the social networking system 930 allow the connection to be indirect via one or more levels of connections or degrees of separation.

In addition to establishing and maintaining connections between users and allowing interactions between users, the social networking system 930 provides users with the ability to take actions on various types of items supported by the social networking system 930. These items may include groups or networks (i.e., social networks of people, entities, and concepts) to which users of the social networking system 930 may belong, events or calendar entries in which a user might be interested, computer-based applications that a user may use via the social networking system 930, transactions that allow users to buy or sell items via services provided by or through the social networking system 930, and interactions with advertisements that a user may perform on or off the social networking system 930. These are just a few examples of the items upon which a user may act on the social networking system 930, and many others are possible. A user may interact with anything that is capable of being represented in the social networking system 930 or in the external system 920, separate from the social networking system 930, or coupled to the social networking system 930 via the network 950.

The social networking system 930 is also capable of linking a variety of entities. For example, the social networking system 930 enables users to interact with each other as well as external systems 920 or other entities through an API, a web service, or other communication channels. The social networking system 930 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 930. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 930 modifies edges connecting the various nodes to reflect the relationships and interactions.

The social networking system 930 also includes user-generated content, which enhances a user's interactions with the social networking system 930. User-generated content may include anything a user can add, upload, send, or “post” to the social networking system 930. For example, a user communicates posts to the social networking system 930 from a user device 910. Posts may include data such as status updates or other textual data, location information, images such as photos, videos, links, music or other similar data and/or media. Content may also be added to the social networking system 930 by a third party. Content “items” are represented as objects in the social networking system 930. In this way, users of the social networking system 930 are encouraged to communicate with each other by posting text and content items of various types of media through various communication channels. Such communication increases the interaction of users with each other and increases the frequency with which users interact with the social networking system 930.

The social networking system 930 includes a web server 932, an API request server 934, a user profile store 936, a connection store 938, an action logger 940, an activity log 942, and an authorization server 944. In an embodiment of the invention, the social networking system 930 may include additional, fewer, or different components for various applications. Other components, such as network interfaces, security mechanisms, load balancers, failover servers, management and network operations consoles, and the like are not shown so as to not obscure the details of the system.

The user profile store 936 maintains information about user accounts, including biographic, demographic, and other types of descriptive information, such as work experience, educational history, hobbies or preferences, location, and the like that has been declared by users or inferred by the social networking system 930. This information is stored in the user profile store 936 such that each user is uniquely identified. The social networking system 930 also stores data describing one or more connections between different users in the connection store 938. The connection information may indicate users who have similar or common work experience, group memberships, hobbies, or educational history. Additionally, the social networking system 930 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 930, such as non-person entities, buckets, cluster centers, images, interests, pages, external systems, concepts, and the like are also stored in the connection store 938.

The social networking system 930 maintains data about objects with which a user may interact. To maintain this data, the user profile store 936 and the connection store 938 store instances of the corresponding type of objects maintained by the social networking system 930. Each object type has information fields that are suitable for storing information appropriate to the type of object. For example, the user profile store 936 contains data structures with fields suitable for describing a user's account and information related to a user's account. When a new object of a particular type is created, the social networking system 930 initializes a new data structure of the corresponding type, assigns a unique object identifier to it, and begins to add data to the object as needed. This might occur, for example, when a user becomes a user of the social networking system 930, the social networking system 930 generates a new instance of a user profile in the user profile store 936, assigns a unique identifier to the user account, and begins to populate the fields of the user account with information provided by the user.

The connection store 938 includes data structures suitable for describing a user's connections to other users, connections to external systems 920 or connections to other entities. The connection store 938 may also associate a connection type with a user's connections, which may be used in conjunction with the user's privacy setting to regulate access to information about the user. In an embodiment of the invention, the user profile store 936 and the connection store 938 may be implemented as a federated database.

Data stored in the connection store 938, the user profile store 936, and the activity log 942 enables the social networking system 930 to generate the social graph that uses nodes to identify various objects and edges connecting nodes to identify relationships between different objects. For example, if a first user establishes a connection with a second user in the social networking system 930, user accounts of the first user and the second user from the user profile store 936 may act as nodes in the social graph. The connection between the first user and the second user stored by the connection store 938 is an edge between the nodes associated with the first user and the second user. Continuing this example, the second user may then send the first user a message within the social networking system 930. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 930 (or, alternatively, in an image maintained by another system outside of the social networking system 930). The image may itself be represented as a node in the social networking system 930. This tagging action may create edges between the first user and the second user as well as create an edge between each of the users and the image, which is also a node in the social graph. In yet another example, if a user confirms attending an event, the user and the event are nodes obtained from the user profile store 936, where the attendance of the event is an edge between the nodes that may be retrieved from the activity log 942. By generating and maintaining the social graph, the social networking system 930 includes data describing many different types of objects and the interactions and connections among those objects, providing a rich source of socially relevant information.

The web server 932 links the social networking system 930 to one or more user devices 910 and/or one or more external systems 920 via the network 950. The web server 932 serves web pages, as well as other web-related content, such as Java, JavaScript, Flash, XML, and so forth. The web server 932 may include a mail server or other messaging functionality for receiving and routing messages between the social networking system 930 and one or more user devices 910. The messages can be instant messages, queued messages (e.g., email), text and SMS messages, or any other suitable messaging format.

The API request server 934 allows one or more external systems 920 and user devices 910 to call access information from the social networking system 930 by calling one or more API functions. The API request server 934 may also allow external systems 920 to send information to the social networking system 930 by calling APIs. The external system 920, in one embodiment, sends an API request to the social networking system 930 via the network 950, and the API request server 934 receives the API request. The API request server 934 processes the request by calling an API associated with the API request to generate an appropriate response, which the API request server 934 communicates to the external system 920 via the network 950. For example, responsive to an API request, the API request server 934 collects data associated with a user, such as the user's connections that have logged into the external system 920, and communicates the collected data to the external system 920. In another embodiment, the user device 910 communicates with the social networking system 930 via APIs in the same manner as external systems 920.

The action logger 940 is capable of receiving communications from the web server 932 about user actions on and/or off the social networking system 930. The action logger 940 populates the activity log 942 with information about user actions, enabling the social networking system 930 to discover various actions taken by its users within the social networking system 930 and outside of the social networking system 930. Any action that a particular user takes with respect to another node on the social networking system 930 may be associated with each user's account, through information maintained in the activity log 942 or in a similar database or other data repository. Examples of actions taken by a user within the social networking system 930 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 930, the action is recorded in the activity log 942. In one embodiment, the social networking system 930 maintains the activity log 942 as a database of entries. When an action is taken within the social networking system 930, an entry for the action is added to the activity log 942. The activity log 942 may be referred to as an action log.

Additionally, user actions may be associated with concepts and actions that occur within an entity outside of the social networking system 930, such as an external system 920 that is separate from the social networking system 930. For example, the action logger 940 may receive data describing a user's interaction with an external system 920 from the web server 932. In this example, the external system 920 reports a user's interaction according to structured actions and objects in the social graph.

Other examples of actions where a user interacts with an external system 920 include a user expressing an interest in an external system 920 or another entity, a user posting a comment to the social networking system 930 that discusses an external system 920 or a web page 922a within the external system 920, a user posting to the social networking system 930 a Uniform Resource Locator (URL) or other identifier associated with an external system 920, a user attending an event associated with an external system 920, or any other action by a user that is related to an external system 920. Thus, the activity log 942 may include actions describing interactions between a user of the social networking system 930 and an external system 920 that is separate from the social networking system 930.

The authorization server 944 enforces one or more privacy settings of the users of the social networking system 930. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 920, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 920. One embodiment allows the specification of the set of entities to comprise an enumeration of entities. For example, the user may provide a list of external systems 920 that are allowed to access certain information. Another embodiment allows the specification to comprise a set of entities along with exceptions that are not allowed to access the information. For example, a user may allow all external systems 920 to access the user's work information, but specify a list of external systems 920 that are not allowed to access the work information. Certain embodiments call the list of exceptions that are not allowed to access certain information a “block list”. External systems 920 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 944 contains logic to determine if certain information associated with a user can be accessed by a user's friends, external systems 920, and/or other applications and entities. The external system 920 may need authorization from the authorization server 944 to access the user's more private and sensitive information, such as the user's work phone number. Based on the user's privacy settings, the authorization server 944 determines if another user, the external system 920, an application, or another entity is allowed to access information associated with the user, including information about actions taken by the user.

In some embodiments, the user device 910 can include a locational media content sharing module 918. The locational media content sharing module 918 can, for example, be implemented as the locational media content sharing module 102 of FIG. 1. The locational media content sharing module 918 can be configured to facilitate determining a current location of a first user. The locational media content sharing module 918 can also be configured to facilitate identifying a set of users who are associated with the first user. Further, the locational media content sharing module 918 can be configured to facilitate determining that a second user out of the set of users is currently located within an allowable proximity from the current location of the first user. Moreover, the locational media content sharing module 918 can be configured to facilitate sharing with the second user a first set of media content items produced by the first user. Other features of the locational media content sharing module 918 are discussed herein in connection with the locational media content sharing module 102.

### Hardware Implementation

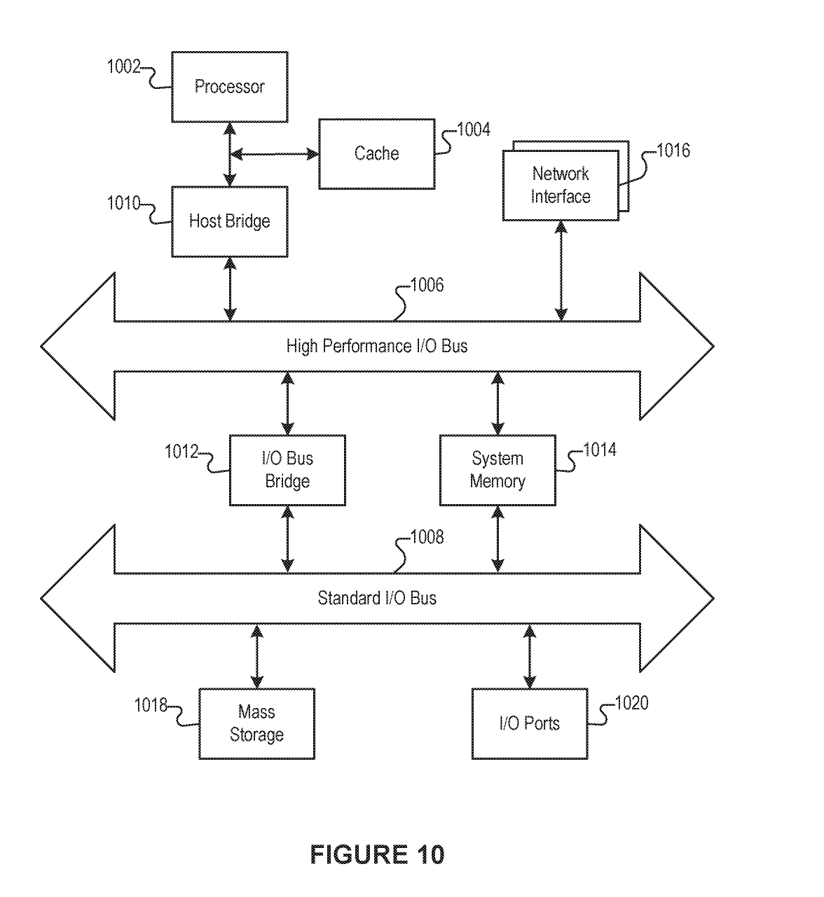

The foregoing processes and features can be implemented by a wide variety of machine and computer system architectures and in a wide variety of network and computing environments. FIG. 10 illustrates an example of a computer system 1000 that may be used to implement one or more of the embodiments described herein in accordance with an embodiment of the invention. The computer system 1000 includes sets of instructions for causing the computer system 1000 to perform the processes and features discussed herein. The computer system 1000 may be connected (e.g., networked) to other machines. In a networked deployment, the computer system 1000 may operate in the capacity of a server machine or a client machine in a client-server network environment, or as a peer machine in a peer-to-peer (or distributed) network environment. In an embodiment of the invention, the computer system 1000 may be the social networking system 930, the user device 910, and the external system 1020, or a component thereof. In an embodiment of the invention, the computer system 1000 may be one server among many that constitutes all or part of the social networking system 930.

The computer system 1000 includes a processor 1002, a cache 1004, and one or more executable modules and drivers, stored on a computer-readable medium, directed to the processes and features described herein. Additionally, the computer system 1000 includes a high performance input/output (I/O) bus 1006 and a standard I/O bus 1008. A host bridge 1010 couples processor 1002 to high performance I/O bus 1006, whereas I/O bus bridge 1012 couples the two buses 1006 and 1008 to each other. A system memory 1014 and one or more network interfaces 1016 couple to high performance I/O bus 1006. The computer system 1000 may further include video memory and a display device coupled to the video memory (not shown). Mass storage 1018 and I/O ports 1020 couple to the standard I/O bus 1008. The computer system 1000 may optionally include a keyboard and pointing device, a display device, or other input/output devices (not shown) coupled to the standard I/O bus 1008. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 1000, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 1000 are described in greater detail below. In particular, the network interface 1016 provides communication between the computer system 1000 and any of a wide range of networks, such as an Ethernet (e.g., IEEE 802.3) network, a backplane, etc. The mass storage 1018 provides permanent storage for the data and programming instructions to perform the above-described processes and features implemented by the respective computing systems identified above, whereas the system memory 1014 (e.g., DRAM) provides temporary storage for the data and programming instructions when executed by the processor 1002. The I/O ports 1020 may be one or more serial and/or parallel communication ports that provide communication between additional peripheral devices, which may be coupled to the computer system 1000.

The computer system 1000 may include a variety of system architectures, and various components of the computer system 1000 may be rearranged. For example, the cache 1004 may be on-chip with processor 1002. Alternatively, the cache 1004 and the processor 1002 may be packed together as a “processor module”, with processor 1002 being referred to as the “processor core”. Furthermore, certain embodiments of the invention may neither require nor include all of the above components. For example, peripheral devices coupled to the standard I/O bus 1008 may couple to the high performance I/O bus 1006. In addition, in some embodiments, only a single bus may exist, with the components of the computer system 1000 being coupled to the single bus. Moreover, the computer system 1000 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 1000 that, when read and executed by one or more processors, cause the computer system 1000 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 1000, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 1002. Initially, the series of instructions may be stored on a storage device, such as the mass storage 1018. However, the series of instructions can be stored on any suitable computer readable storage medium. Furthermore, the series of instructions need not be stored locally, and could be received from a remote storage device, such as a server on a network, via the network interface 1016. The instructions are copied from the storage device, such as the mass storage 1018, into the system memory 1014 and then accessed and executed by the processor 1002. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 1000 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to one embodiment“, an embodiment”, “other embodiments”, one series of embodiments“, some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, that a first user has provided a first media content item;
identifying, by the computing system, at least a second user associated with the first user;
sharing, by the computing system, with at least the second user the first media content item;
determining, by the computing system, that the second user has provided a second media content item in association with the first media content item; and
sharing, by the computing system, with the first user the second media content item provided by the second user in association with the first media content item.

2. The computer-implemented method of claim 1, wherein determining that the second user has provided the second media content item in association with the first media content item further comprises:
acquiring information associated with the first media content item; and
determining that the second media content item provided by the second user is associated with the information associated with the first media content item.

3. The computer-implemented method of claim 2, wherein the information associated with the first media content item includes at least one of a topic, a theme, a title, a label, a tag, an event, a location, or an entity.

4. The computer-implemented method of claim 2, wherein the information associated with the first media content item is generated based on the first user.

5. The computer-implemented method of claim 1, further comprising:
identifying a third user associated with at least one of the first user or the second user; and
sharing, with the third user, the first media content item and the second media content item.

6. The computer-implemented method of claim 5, further comprising:
determining that the third user has provided a third media content item in association with at least one of the first media content item or the second media content item; and
sharing, with the first user and the second user, the third media content item provided by the third user in association with the at least one of the first media content item or the second media content item.

7. The computer-implemented method of claim 1, wherein identifying at least the second user associated with the first user is based on at least one of a social connection with the first user or an instruction from the first user.

8. A system comprising:
at least one processor; and
a memory storing instructions that, when executed by the at least one processor, cause the system to perform:
determining that a first user has provided a first media content item;
identifying at least a second user associated with the first user;
sharing with at least the second user the first media content item;
determining that at least the second user has provided a second media content item in association with the first media content item; and
sharing with the first user the second media content item provided by the second user in association with the first media content item.

9. The system of claim 8, wherein determining that the second user has provided the second media content item in association with the first media content item further comprises:
acquiring information associated with the first media content item; and
determining that the second media content item provided by the second user is associated with the information associated with the first media content item.

10. The system of claim 9, wherein the information associated with the first media content item includes at least one of a topic, a theme, a title, a label, a tag, an event, a location, or an entity.

11. The system of claim 9, wherein the information associated with the first media content item is generated based on the first user.

12. The system of claim 8, wherein the instructions cause the system to further perform:
identifying a third user associated with at least one of the first user or the second user; and
sharing, with the third user, the first media content item and the second media content item.

13. The system of claim 12, wherein the instructions cause the system to further perform:
determining that the third user has provided a third media content item in association with at least one of the first media content item or the second media content item; and
sharing, with the first user and the second user, the third media content item provided by the third user in association with the at least one of the first media content item or the second media content item.

14. The system of claim 8, wherein identifying at least the second user associated with the first user is based on at least one of a social connection with the first user or an instruction from the first user.

15. A non-transitory computer-readable storage medium including instructions that, when executed by at least one processor of a computing system, cause the computing system to perform a method comprising:
determining that a first user has provided a first media content item;
identifying at least a second user associated with the first user;
sharing with at least the second user the first media content item;
determining that at least the second user has provided a second media content item in association with the first media content item; and
sharing with the first user the second media content item provided by the second user in association with the first media content item.

16. The non-transitory computer-readable storage medium of claim 15, wherein determining that the second user has provided the second media content item in association with the first media content item further comprises:
acquiring information associated with the first media content item; and
determining that the second media content item provided by the second user is associated with the information associated with the first media content item.

17. The non-transitory computer-readable storage medium of claim 16, wherein the information associated with the first media content item includes at least one of a topic, a theme, a title, a label, a tag, an event, a location, or an entity.

18. The non-transitory computer-readable storage medium of claim 16, wherein the information associated with the first media content item is generated based on the first user.

19. The non-transitory computer-readable storage medium of claim 15, wherein the instructions cause the computing system to further perform:
identifying a third user associated with at least one of the first user or the second user; and
sharing, with the third user, the first media content item and the second media content item.

20. The non-transitory computer-readable storage medium of claim 19, wherein the instructions cause the computing system to further perform:
determining that the third user has provided a third media content item in association with at least one of the first media content item or the second media content item; and
sharing, with the first user and the second user, the third media content item provided by the third user in association with the at least one of the first media content item or the second media content item.
